(19) United States
(12) Patent Application Publication
(10) Pub. No.: US 2025/0037158 A1
(43) Pub. Date: Jan. 30, 2025

(54) SYSTEM AND METHOD FOR COMPUTING CLUSTERING RELEVANCE IN VOLATILE DATA ENVIRONMENT AND ADJUSTING CLUSTERING COMPOSITION FOR IMPROVED ACCURACY

(71) Applicant: JPMorgan Chase Bank, N.A., New York, NY (US)

(72) Inventors: Freddy LECUE, Mamaroneck, NY (US); Leonidas TSEPENEKAS, College Park, MD (US); Daniele MAGAZZENI, London (GB); Yibei MCDERMOTT, West New York, NJ (US); Jackie HO, New York, NY (US); Barney O'KANE, Darien, CT (US); Sebastian TUDOR, Hoboken, NJ (US); Andreas KOUKORINIS, London (GB)

(73) Assignee: JPMorgan Chase Bank, N.A., New York, NY (US)

(21) Appl. No.: 18/228,971

(22) Filed: Aug. 1, 2023

(30) Foreign Application Priority Data
Jul. 25, 2023 (GR) 20230100614

(51) Int. Cl. G06Q 30/0201

(52) U.S. Cl. CPC G06Q 30/0206

(57) ABSTRACT

A method and system for determining clustering relevance in a volatile data environment and adjusting clustering composition for improved accuracy are disclosed. The method includes plotting a dataset and generating at least one grand truth data value, and clustering the plotted dataset for generating data clusters, in which the clustering is performed based on correlation of individual data values included in the dataset. The method further includes independently training machine learning (ML) algorithm for each of the data clusters for generating a managing ML algorithm for the dataset, applying the managing ML algorithm to the dataset for predicting at least one future data value, and comparing differences between the grand truth data value and the future data value for estimating a clustering error, and adjusting composition of at least one of the plurality of data clusters based on the estimated clustering error.

### CROSS-REFERENCE TO RELATED APPLICATIONS

This application claims the benefit of Greek patent application No. 20230100614, filed Jul. 25, 2023, which is hereby incorporated by reference in its entirety.

### TECHNICAL FIELD

This disclosure generally relates to computing and adjusting fluctuating metrics in a volatile environment. More specifically, this disclosure is directed to computing and adjusting data correspondence with respect to time in data clusters of a dataset in a volatile data environment and adjusting composition of such clusters to reflect changing data correspondence.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Limited data in a volatile environment may provide difficulty in providing reliable prediction of future data, as certain groups of data may have different correspondence from other data within a dataset. Further, correspondence within certain groups of data may often change with time whereas other groups of data may remain stable. Accordingly, it may be difficult to generate accurate predictive data in volatile data environments as relationships between data may be unstable.

In select contexts, bond market may be highly volatile and difficult to predict with reliable accuracy. Further, bond pricing may be very difficult to predict especially since bonds are not necessarily traded with high throughput. More specifically, limited trading or throughput may lead to problems with limited traces and data for certain bonds. Accordingly, conventional data models may be unsuitable to perform meaningful data prediction in such an environment.

### SUMMARY

According to an aspect of the present disclosure, a method for determining clustering relevance in a volatile data environment and adjusting clustering composition for improved accuracy is provided. The method includes plotting, via a processor, a time series dataset; generating, by executing a machine learning (ML) algorithm via the processor and based on the plotted time series dataset, at least one grand truth data value; clustering, via the processor, the plotted time series dataset for generating multiple of data clusters, wherein the clustering is performed based on data correlation of individual data values included in the time series dataset; training, via the processor, the ML algorithm independently for each of the multiple data clusters for generating a managing ML algorithm, the managing ML algorithm including multiple sub-ML algorithms for each of the multiple data clusters; applying, by executing the managing ML algorithm via the processor to the time series dataset for predicting at least one future data value; comparing, via the processor, differences between the at least one grand truth data value and the at least one future data value for estimating clustering error; and adjusting, via the processor, composition of at least one of the multiple data clusters based on the estimated clustering error.

According to another aspect of the present disclosure, the method further includes performing data pre-processing operation on the time series dataset.

According to another aspect of the present disclosure, the data pre-processing operation includes at least one of normalization, data imputation, and outlier removal.

According to yet another aspect of the present disclosure, the managing machine learning model includes a combination of neural network models and linear models.

According to another aspect of the present disclosure, a data value included in the time series dataset is determined not to belong in an assigned cluster when an error value of the data value is above a reference threshold.

According to a further aspect of the present disclosure, a data value included in the time series dataset is determined not to belong in an assigned cluster when a distance of an error value of the data value is beyond a reference distance from an error value of another data value in the assigned cluster.

According to yet another aspect of the present disclosure, a data value included in the time series dataset is determined to belong in an assigned cluster when (i) when an error value of the data value is at or below a reference threshold, and (ii) a distance of the error value of the data value is within a reference distance from an error value of another data value in the assigned cluster.

According to a further aspect of the present disclosure, the method further includes plotting, via the processor, the at least one grand truth data value.

According to another aspect of the present disclosure, the method further includes: outputting, via the processor, at least one of: an explanation of why the composition of at least one of the multiple data clusters was adjusted, a new clustering strategy with stronger weight on new data characteristics, and new data values based on the adjusting of the composition of at least one of the multiple data clusters.

According to a further aspect of the present disclosure, the estimating of the clustering error includes: in each of the multiple data clusters; retrieving data functions of data values in a data cluster; computing a correlation of each pair of data functions for determining correlations of the data values in the data cluster; and measuring the correlations for estimating a clustering error of the data cluster.

According to a further aspect of the present disclosure, the method further includes modifying a weight for the clustering based on the adjusting of the composition of at least one of the multiple data clusters.

According to a further aspect of the present disclosure, the time series dataset includes multiple bond prices.

According to a further aspect of the present disclosure, the adjusting indicates a change in correlation of the time series dataset over time.

According to a further aspect of the present disclosure, the adjusting includes modifying the composition of at least one of the multiple data clusters for maximizing intra-cluster correlation.

According to a further aspect of the present disclosure, the adjusting includes modifying the composition of at least one of the multiple data clusters for maximizing intra-cluster correlation minus out-of-cluster correlation.

According to a further aspect of the present disclosure, the correlation of data values included in the time series dataset is measured via Pearson's coefficient.

According to a further aspect of the present disclosure, each data value included in the time series dataset includes multiple dimensions utilized in the clustering.

According to a further aspect of the present disclosure, the multiple dimensions include maturity, ticker and industry type.

According to an aspect of the present disclosure, a system for determining clustering relevance in a volatile data environment and adjusting clustering composition for improved accuracy is provided. The system includes a memory, a display and a processor. The processor is configured to perform: plotting a time series dataset; generating, by executing a ML algorithm and based on the plotted time series dataset, at least one grand truth data value; clustering the plotted time series dataset for generating multiple data clusters, wherein the clustering is performed based on data correlation of individual data values included in the time series dataset; training the ML algorithm independently for each of the multiple data clusters for generating a managing ML algorithm, the managing ML algorithm including multiple sub-ML algorithms for each of the multiple data clusters; applying, by executing the managing ML algorithm to the time series dataset for predicting at least one future data value; comparing differences between the at least one grand truth data value and the at least one future data value for estimating clustering error; and adjusting composition of at least one of the multiple data clusters based on the estimated clustering error.

According to another aspect of the present disclosure, a non-transitory computer readable storage medium that stores a computer program for determining clustering relevance in a volatile data environment and adjusting clustering composition for improved accuracy is provided. The computer program, when executed by a processor, causes a system to perform multiple processes including: plotting a time series dataset; generating, by executing a ML algorithm and based on the plotted time series dataset, at least one grand truth data value; clustering the plotted time series dataset for generating multiple data clusters, wherein the clustering is performed based on data correlation of individual data values included in the time series dataset; training the ML algorithm independently for each of the multiple data clusters for generating a managing ML algorithm, the managing ML algorithm including multiple sub-ML algorithms for each of the multiple data clusters; applying, by executing the managing ML algorithm to the time series dataset for predicting at least one future data value; comparing differences between the at least one grand truth data value and the at least one future data value for estimating clustering error; and adjusting composition of at least one of the multiple data clusters based on the estimated clustering error.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a cluster adjustment system in accordance with an exemplary embodiment.

FIG. 2 illustrates an exemplary diagram of a network environment with a cluster adjustment system in accordance with an exemplary embodiment.

FIG. 3 illustrates a system diagram for implementing a cluster adjustment system in accordance with an exemplary embodiment.

FIG. 4 illustrates a method for performing cluster adjustment of time series data in a volatile environment in accordance with an exemplary embodiment.

FIGS. 5A-5B illustrate plotting of time series dataset and grand truth data values in different organizations in accordance with an exemplary embodiment.

FIGS. 6A-6B illustrate a graph generated using pre-processed dataset for different organizations in accordance with an exemplary embodiment.

FIG. 7 illustrates clustering performed on a plotted time series dataset in accordance with an exemplary embodiment.

FIG. 8 illustrates a relationship of a managing machine learning (ML) model with respect to its sub-ML models in accordance with an exemplary embodiment.

FIGS. 9A-9B illustrate plotting of future values estimated using a managing ML model for different organizations in accordance with an exemplary embodiment.

FIGS. 10A-10B illustrate plotting of future values estimated using a managing ML model together with grand truth values for different organizations in accordance with an exemplary embodiment.

FIGS. 11A-11B illustrate error estimation results for different organizations based on initial clustering in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

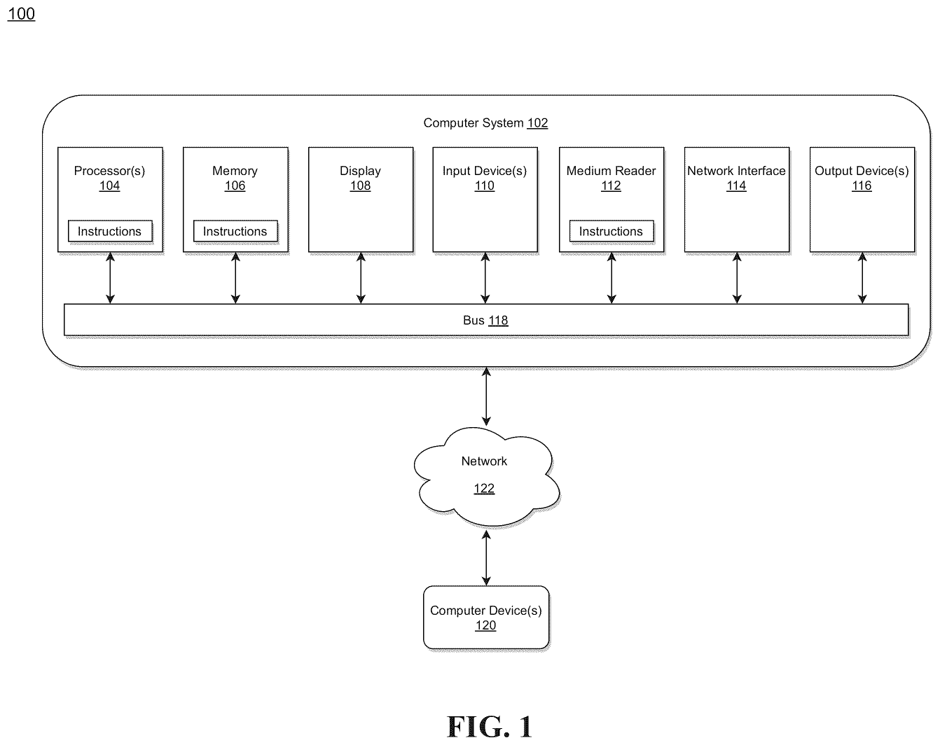

FIG. 1 illustrates a computer system for implementing a cluster adjustment system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

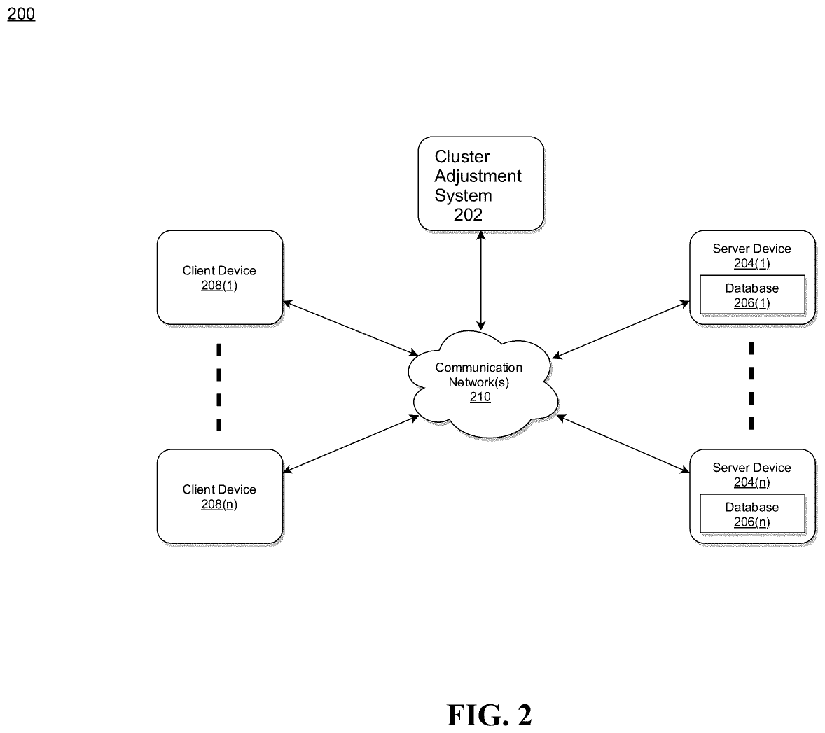

FIG. 2 illustrates an exemplary diagram of a network environment with a cluster adjustment system in accordance with an exemplary embodiment.

A cluster adjustment system 202 may be implemented with one or more computer systems similar to the computer system 102 as described with respect to FIG. 1.

The cluster adjustment system 202 may store one or more applications that can include executable instructions that, when executed by the cluster adjustment system 202, cause the cluster adjustment system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the cluster adjustment system 202 itself, may be located in virtual server(s) running in a cloud-based computing environment rather than being tied to one or more specific physical network computing devices. Also, the application(s) may be running in one or more virtual machines (VMs) executing on the cluster adjustment system 202. Additionally, in one or more embodiments of this technology, virtual machine(s) running on the cluster adjustment system 202 may be managed or supervised by a hypervisor.

In the network environment 200 of FIG. 2, the cluster adjustment system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the cluster adjustment system 202, such as the network interface 114 of the computer system 102 of FIG. 1, operatively couples and communicates between the cluster adjustment system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the cluster adjustment system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The cluster adjustment system 202 may be a standalone device or integrated with one or more other devices or apparatuses, such as one or more of the server devices 204(1)-204(n), for example. In one particular example, the cluster adjustment system 202 may be hosted by one of the server devices 204(1)-204(n), and other arrangements are also possible. Moreover, one or more of the devices of the cluster adjustment system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the cluster adjustment system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the cluster adjustment system 202 that may efficiently provide a platform for implementing a cloud native cluster adjustment system module, but the disclosure is not limited thereto.

The client devices 208(1)-208(n) may run interface applications, such as standard web browsers or standalone client applications, which may provide an interface to communicate with the cluster adjustment system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the cluster adjustment system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the cluster adjustment system 202, the server devices 204(1)-204(n), or the client devices 208(1)-208(n), for example, may be configured to operate as virtual instances on the same physical machine. For example, one or more of the cluster adjustment system 202, the server devices 204(1)-204(n), or the client devices 208(1)-208(n) may operate on the same physical device rather than as separate devices communicating through communication network(s) 210. Additionally, there may be more or fewer cluster adjustment system 202, server devices 204(1)-204(n), or client devices 208(1)-208(n) than illustrated in FIG. 2. According to exemplary embodiments, the cluster adjustment system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

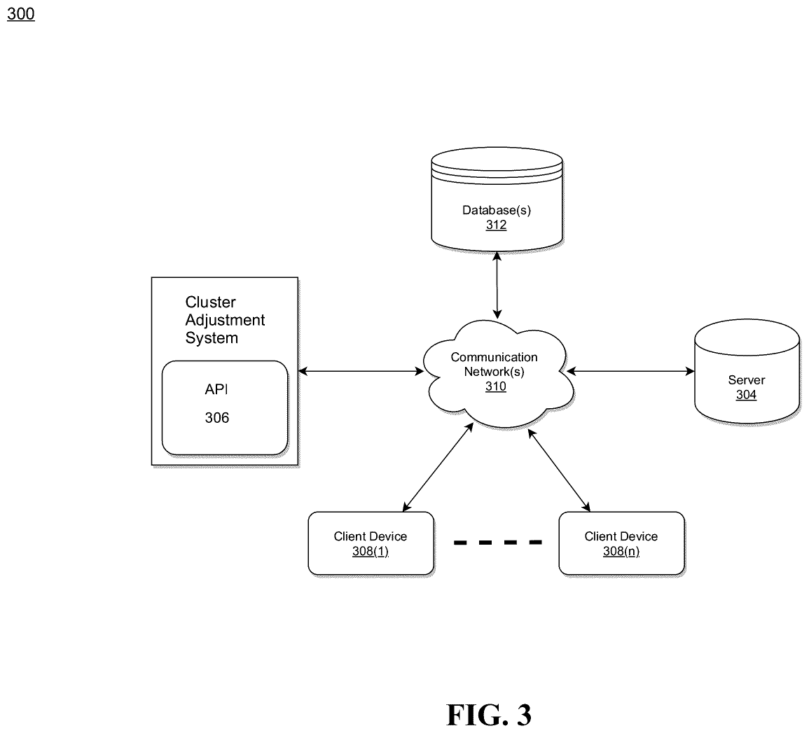

FIG. 3 illustrates a system diagram for implementing a cluster adjustment system in accordance with an exemplary embodiment.

As illustrated in FIG. 3, the system 300 may include a cluster adjustment system 302 within which a group of API modules 306 is embedded, a server 304, a database(s) 312, a plurality of client devices 308(1) . . . 308(n), and a communication network 310.

According to exemplary embodiments, the cluster adjustment system 302 including the API modules 306 may be connected to the server 304, and the database(s) 312 via the communication network 310. Although there is only one database that has been illustrated, the disclosure is not limited thereto. Any number of databases may be utilized. The cluster adjustment system 302 may also be connected to the plurality of client devices 308(1) . . . 308(n) via the communication network 310, but the disclosure is not limited thereto.

According to exemplary embodiment, the cluster adjustment system 302 is described and shown in FIG. 3 as including the API modules 306, although it may include other rules, policies, modules, databases, or applications, for example. According to exemplary embodiments, the database(s) 312 may be embedded within the cluster adjustment system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable cluster adjustment system as a service for a desired data processing scheme. The UI platform may include an input interface layer and an output interface layer. The input interface layer may request preset input fields to be provided by a user in accordance with a selection of an automation template. The UI platform may receive user input via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the cluster adjustment system 302. In this regard, the plurality of client devices 308(1) . . . 308(n) may be “clients” of the cluster adjustment system 302 and are described herein as such. Nevertheless, it is to be known and understood that the plurality of client devices 308(1) . . . 308(n) need not necessarily be “clients” of the cluster adjustment system 302, or any entity described in association therewith herein. Any additional or alternative relationship may exist between either or both of the plurality of client devices 308(1) . . . 308(n) and the cluster adjustment system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the cluster adjustment system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The cluster adjustment system 302 may be the same or similar to the cluster adjustment system 202 as described with respect to FIG. 2, including any features or combination of features described with respect thereto.

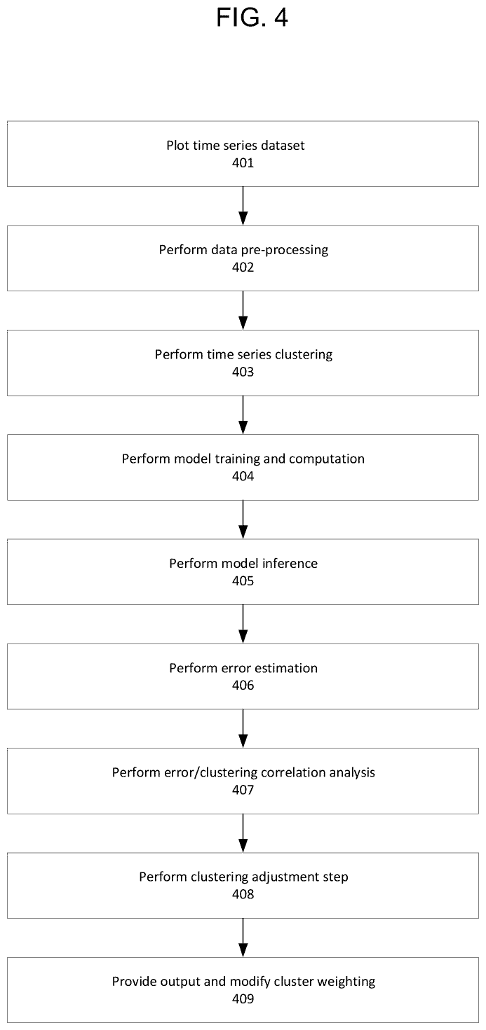

FIG. 4 illustrates a method for performing an adjustment in data clusters in a volatile data environment in accordance with an exemplary embodiment.

According to exemplary aspects, data correlations may be utilized or leveraged to improve or optimize convergence of learning method. More specifically, exemplary aspects are directed to address how to retrain a learning model when unobservable conditions, such as in markets, are changing. Examples of such may include generation of bond pricing or predicting stock pricing that account for unobservable environmental changes. In such examples, inputs may include, without limitation, time series of bonds history, bonds description along with several dimensions, e.g., maturity, ticker or industry type. Based on such inputs, bond price output may be provided. In an example, bond price outputs may represent bond prices that are adjusted to the new unobservable conditions (e.g., market conditions) with one or more explanations highlighting the reasons of pricing strategy modification.

According to exemplary aspects, novel algorithm that considers dynamic bonds correlation in estimating and computing adjustable bonds pricing is provided. In an example, dynamic bond correlations may reference a situation where dynamic dimension is captured through volatility of the market.

In operation 401, time series data inputs may be plotted for various entities or organizations. According to exemplary aspects, a time range for plotting the time series data may be predefined or customized. For example, the pre-processed data for a predefined time range (e.g., past 30, 60, 90, 120, 150, 180 or any other duration of days), may be plotted. Alternatively, customized start and end dates may be specified for the time-series plot.

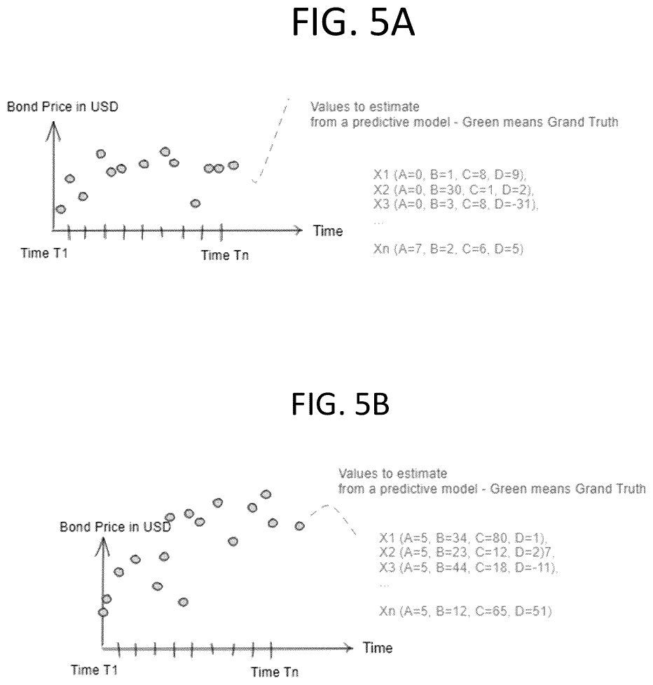

For example, initial plots for timeseries datasets for organization 1 and organization 2 are provided in FIGS. 5A and 5B, respectively. In an example, FIG. 5A illustrates highly volatile bond (10 year) prices in US dollars (USD) along the Y-axis with corresponding time values along the X-axis. In this example, each of the data points may indicate or correspond to time series prices, maturity, ticker and industry type, which may be represented by variables A, B, C and D, respectively. However, aspects of the present disclosure are not limited thereto, such that each of the data points may indicate or correspond to different information in a volatile environment.

Once the initial data plots are generated, one or more machine learning (ML) or artificial intelligence (AI) algorithms are utilized to generate grand truth values for a specific period. In FIGS. 5A and 5B, the estimated grand truth values may be illustrated as dashed lines. In an example, the specified period may be certain number of days, weeks, months or years. Further, the period may be automatically specified by the ML or AI algorithm or manually set by a user. However, aspects of the present disclosure are not limited thereto, such that the grand truth values may be depicted in different colors, shapes, shade or the like.

FIG. 5B may illustrate similar information as FIG. 5A, such as 10 year bond prices, but for a different organization. Although only two organizations have been illustrated, aspects of the present disclosure are not limited thereto, such that larger number of initial plots for larger number of organizations may be generated.

In operation 402, one or more pre-processing operations may be performed on received input data. According to exemplary aspects, one or more pre-processing operations may be performed for normalization of data, data imputation and identification/removal of outliers.

For example, pre-processing operations may include, without limitation, acquisition of datasets, formatting of datasets, importing of corresponding libraries, identifying and/or handling of missing values or extra values, removing of extraneous data, encoding categorical data, perform grouping or splitting of dataset and the like.

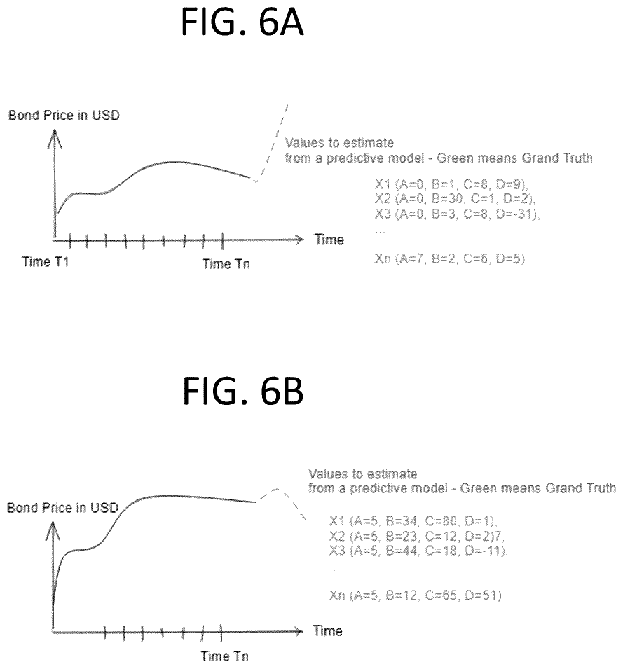

Once the time series data included in the dataset have been pre-processed, a linear graph may be generated based on the pre-processed data. For example, FIGS. 6A and 6B illustrate line graphs that were generated that represent a linear trend of the datasets that were initially plotted in FIGS. 5A and 5B. Moreover, one or more ML or AI algorithms may be utilized to perform future predictions based on the linear graph or trend generated using the pre-processed dataset. According to exemplary aspects, the future predicted values generated using the pre-processed dataset may be more accurate than the future predicted values generated using the initial dataset, due at least in part to normalization of data, data imputation and/or removal of outliers.

In operation 403, time series clustering is performed on the initially plotted datasets in FIGS. 5A and 5B. According to exemplary aspects, in operation 403, initial clustering may be performed based on proximity of data points to one another. For example, if adjacent data points are determined to be within a reference distance of one another, they may be determined to be highly correlated and belong to the same cluster. According to exemplary aspects, clusters may be formed of differing shapes and size.

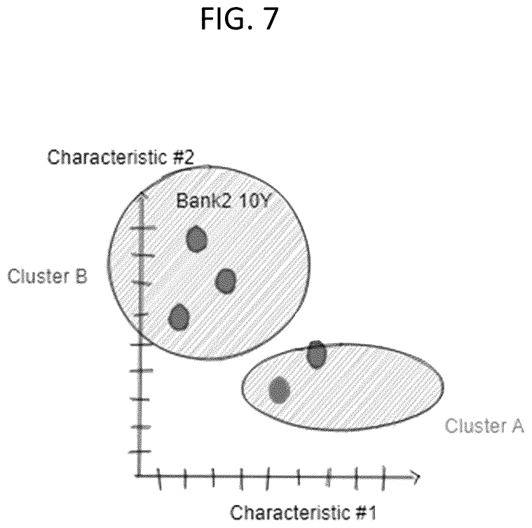

As exemplarily illustrated in FIG. 7, cluster A may be circular in shape and may include data points more than cluster B, which may be elliptical in shape. Each of the clusters may represent differing cluster characteristics. In the bond example, each cluster may represent specific bond characteristics.

According to exemplary aspects, initial clusters of time series data may be constructed in any ad-hoc manner. For example, a cluster may be created by first capturing data characteristics for each of the pre-processed data points in the time series data, and a number of clusters (e.g., k number of clusters) may be generated or computed based on the captured data characteristics. Data characteristics for bond data points may include, maturity, ticker name, industry type and the like.

In operation 404, training of stored ML or AI model algorithms may be performed for computing new or modified ML or AI model algorithms. According to exemplary aspects, the training of the stored ML or AI model algorithms may be performed using the initial data clustering performed in operation 403 and based on the pre-processed dataset and/or the corresponding linear graphs generated in operation 402.

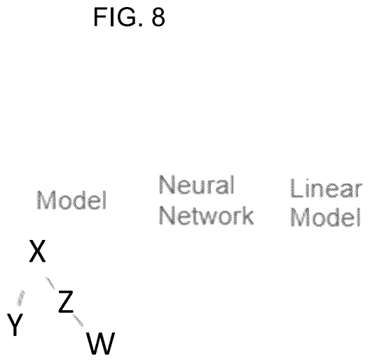

According to exemplary aspects, at least since each of the clusters may indicate differing data relationship or correspondence, one or more of the clusters may be trained with a different machine learning model from the other clusters. As exemplarily illustrated in FIG. 8, the entire dataset (e.g., bond market) may correspond to a managing machine learning model X, which may incorporate or utilizes other machine learning models Y and Z (or sub-machine learning models) that may each correspond to certain clusters of data within the entire dataset. Similarly, machine learning model Z may include one or more sub-machine learning models, such as machine learning model W. Each of the machine learning models Y, Z and W forming the managing machine learning model X may be trained independently for each cluster, with the aim of the clustering being trying to capture underlying correlations that exist within the captured dataset (e.g., bond market). The managing machine learning model X may then be utilized to predict future data values for the entire dataset Any of the models X, Y, Z and W could be of different Machine Learning models e.g., artificial neural networks,

Here, unlike conventional systems that may attempt to fit a single machine learning model to a dataset exemplary aspects of the present disclosure may utilize multiple machine learning models or sub-machine learning models corresponding to differing clusters of data within the dataset to form a new managing machine learning model, which may more accurately process differing data dynamics within individual data clusters within the dataset.

In an example, the ML or AI model algorithms may be trained for computing the new or modified ML or AI model algorithms that may be utilized for predicting future data values/points at a future time interval. Further, according to exemplary aspects, different ML or AI model algorithms may be utilized for training for each of the identified data clusters, and training may be performed independent for each of the clusters of data. More specifically, rather than applying a single ML or AI model algorithm to the aggregated dataset as typically performed, separate or independent training of ML/AI model algorithms may be performed for each of the clusters identified in operation 403. Based on the independent training and formation of new/modified ML or AI model algorithms, underlying correlations for each of the clusters in the dataset may be captured.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, 5-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment the ML or AI models may be generated using at least one from among an artificial neural network technique, a decision tree technique, a support vector machines technique, a Bayesian network technique, and a genetic algorithms technique.

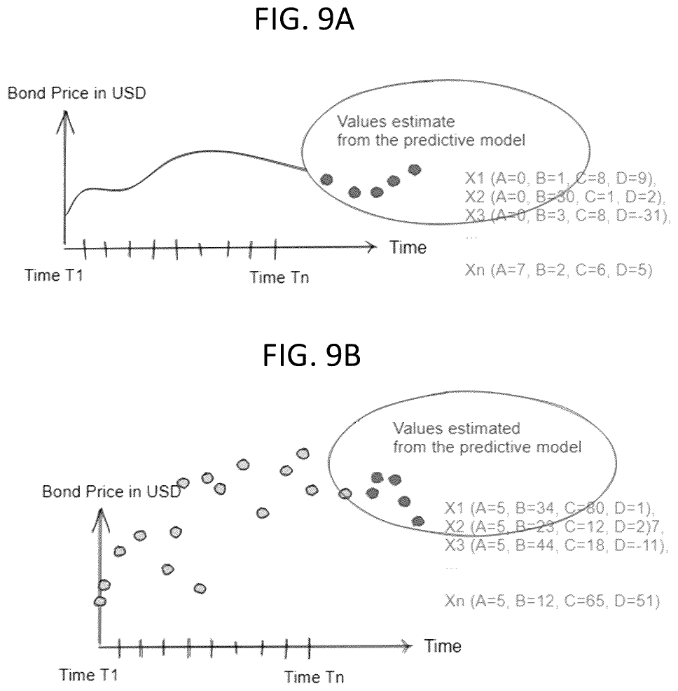

In operation 405, once the machine learning model(s) have been sufficiently trained, model inference may be performed. For example, based on the initial plotting of the time series data, future data values may be predicted using the trained machine learning algorithms. More specifically, the managing machine learning model may be applied on the time series dataset to predict future values in a future time interval. For example, FIG. 9A illustrates predicted future data values in the circled area for organization 1, and FIG. 9B illustrates predicted future data values in the circled area for organization 2. As illustrated in FIGS. 9A-9B, future data value for a future time point may be represented as Xn.

In operation 406, error estimation is performed for estimating errors made during the initial prediction/model inference on time a future time interval. According to exemplary aspects, initially predicted values or grand truth values (see e.g., FIGS. 5A-5B or FIGS. 6A-6B) are then compared against future values predicted using the trained managing machine learning model (see e.g., FIGS. 9A-9B) for determining error estimation between the two sets of values.

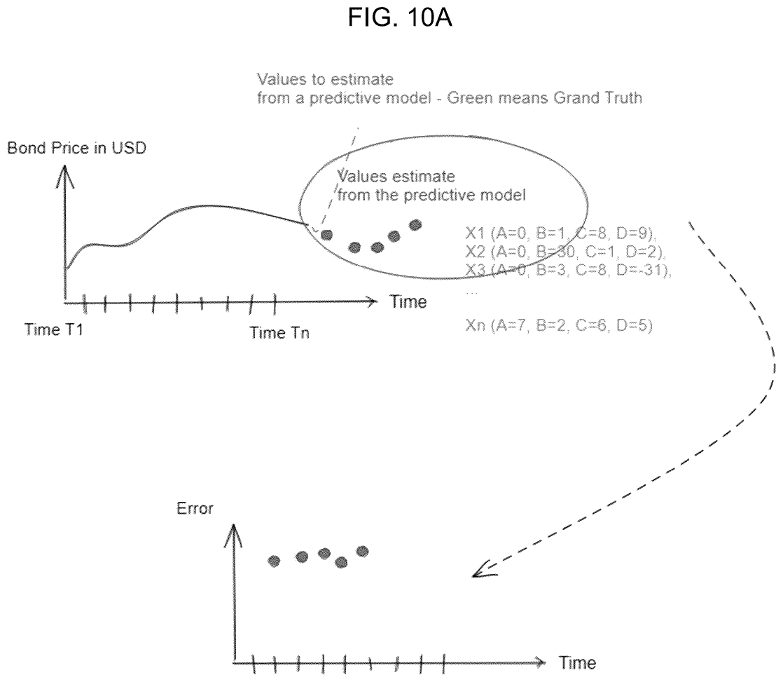

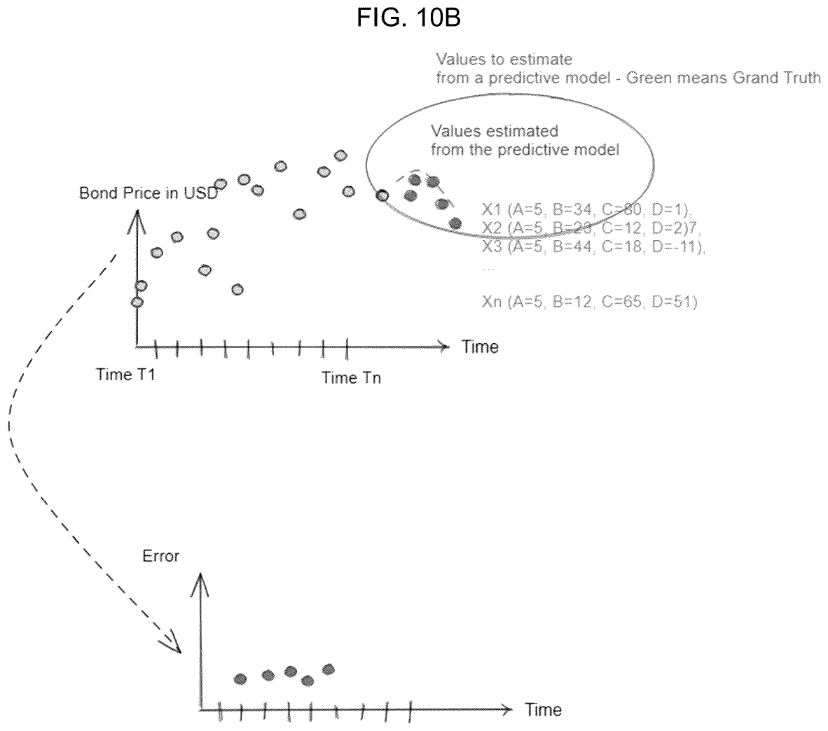

As seen in FIG. 10A, the future values predicted using the trained managing ML model are divergent from the grand truth values initially calculated for organization 1. Such divergence may indicate a presence of material error or at least one data point included in its assigned cluster may no longer belong. In contrast, the future values predicted using the trained managing machine learning model align well with the grand truth values initially calculated for organization 2. Such alignment may indicate that no material error may be present and that all of the data points are properly clustered.

According to exemplary aspects, the error estimation may be performed for each future data value V predicted with the managing machine learning model X by (i) obtaining a corresponding grand truth value v, (ii) estimating an error value by finding a difference between the future data value V and the grand truth value v at a future time interval (see e.g., circled areas of FIGS. 10A-10B, where dashed line represents the grand truth value v, and the dots represent the future data value V), and (iii) obtaining an error estimate at the future time interval. Based on the obtained error estimates for the future time intervals, an average error value is determined. In an example, the average error value may be determined by dividing the obtained error estimates by the number of predicted values. Once the average error values are obtained, then the average error values are plotted as exemplarily illustrated in FIGS. 10A and 10B.

In operation 407, error/clustering correlation analysis is performed based on the plotted error values. For each plotted error value, based on a magnitude of the respective error and proximate distance from other plotted error values, it may be determined whether a particular data value (e.g., bond) is relevant in the cluster to which it was originally assigned.

More specifically, the operation 407 is directed to evaluating relevance of a data value (e.g., bond) in its initially assigned cluster. In an example, the operation 407 may be achieved by (i) retrieving a function of each data value (e.g., price function of each bond value) in a cluster, (ii) compute a correlation of each pair of functions, which may indicate how correlated two data values are, and (iii) measuring the correlation through Pearson's coefficient. Based on the measured correlations, it may be determined whether a data value properly belongs to its assigned cluster or not. For example, if the measured correlation is at or above a reference threshold, then the data value may be determined to be properly assigned. Alternatively, if the measured correlation is below the reference threshold, then the data value may be determined not to belong to the assigned cluster.

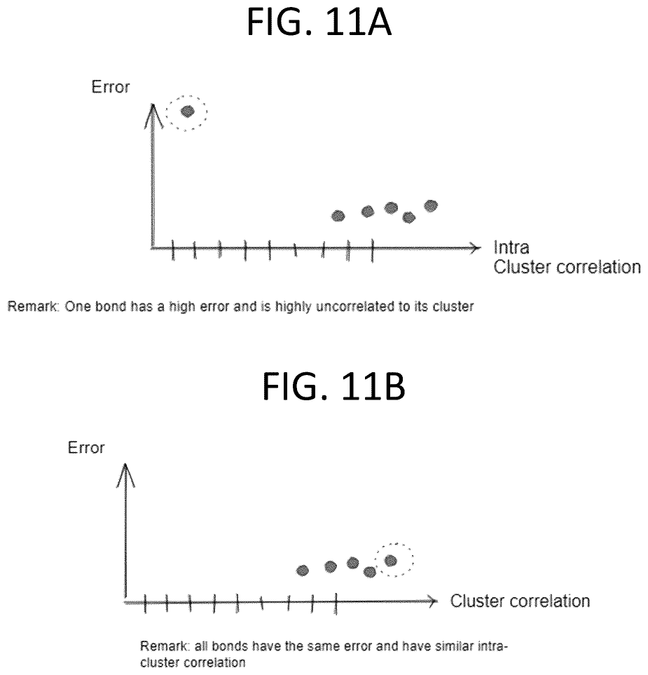

For example, in FIG. 11A, an error value encircled in a dashed circle may show that it has a high error value (e.g., an error value above a reference threshold) and largely uncorrelated to its cluster (e.g., distance of the encircled error value is beyond a reference value from other error values). Accordingly, in this case, the encircled error value may be determined as not being placed in the correct cluster initially.

In contrast, in FIG. 11B, the error value encircled in the dashed circle has a low error value (e.g., an error value below the reference threshold) and largely correlated to its cluster (e.g., distance of the encircled error value is within the reference value from other error values). Accordingly, in this case, the encircled error value may be determined as being placed in the correct cluster initially.

In operation 408, clustering adjustment is performed based on the analysis performed in operation 407. According to exemplary aspects, adjustments may be performed to increase/maximize intra-cluster correlation, or increase/maximize intra-cluster minus out-of-cluster correlation.

More specifically, based on the error/clustering correlation analysis in operation 407, one or more of the initial clusters established in operation 403 is adjusted. In an example, the adjusting of the clusters may include, without limitation, relocating one or more data values from one cluster to another cluster, removing one or more data values from one cluster and setting the one or more removed data values as its/their own cluster or clusters. Alternatively, the one or more removed data values may be removed from the initial cluster without relocating to another cluster.

In operation 409, one or more outputs may be provided and weighting on clustering may be modified in response to the adjustment to the clustering in operation 408. According to exemplary aspects, the outputs may include, without limitation, (1) an explanation of why clustering need to be revisited to improve data accuracy (e.g., bond pricing), (2) new clustering strategy with stronger weight on new data characteristics (e.g., error with intra-cluster correlation, and (3) new data values (e.g., bond prices) based on the new clustering.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for determining clustering relevance in a volatile data environment and adjusting clustering composition for improved accuracy, the method comprising:
plotting, via a processor, a time series dataset;
generating, by executing a machine learning (ML) algorithm via the processor and based on the plotted time series dataset, at least one grand truth data value;
clustering, via the processor, the plotted time series dataset for generating a plurality of data clusters, wherein the clustering is performed based on data correlation of individual data values included in the time series dataset;
training, via the processor, the ML algorithm independently for each of the plurality of data clusters for generating a managing ML algorithm, the managing ML algorithm including a plurality of sub-ML algorithms for each of the plurality of data clusters;
applying, by executing the managing ML algorithm via the processor to the time series dataset for predicting at least one future data value;
comparing, via the processor, differences between the at least one grand truth data value and the at least one future data value for estimating clustering error; and
adjusting, via the processor, composition of at least one of the plurality of data clusters based on the estimated clustering error.

2. The method according to claim 1, further comprising:
performing data pre-processing operation on the time series dataset.

3. The method according to claim 2, wherein the data pre-processing operation includes at least one of normalization, data imputation, and outlier removal.

4. The method according to claim 1, wherein the managing machine learning model includes a combination of neural network models and linear models.

5. The method according to claim 1, wherein a data value included in the time series dataset is determined not to belong in an assigned cluster when an error value of the data value is above a reference threshold.

6. The method according to claim 1, wherein a data value included in the time series dataset is determined not to belong in an assigned cluster when a distance of an error value of the data value is beyond a reference distance from an error value of another data value in the assigned cluster.

7. The method according to claim 1, wherein a data value included in the time series dataset is determined to belong in an assigned cluster when (i) when an error value of the data value is at or below a reference threshold, and (ii) a distance of the error value of the data value is within a reference distance from an error value of another data value in the assigned cluster.

8. The method according to claim 1, further comprising:
plotting, via the processor, the at least one grand truth data value.

9. The method according to claim 1, further comprising:
outputting, via the processor, at least one of:
an explanation of why the composition of at least one of the plurality of data clusters was adjusted,
a new clustering strategy with a stronger weight on new data characteristics, and
new data values based on the adjusting of the composition of at least one of the plurality of data clusters.

10. The method according to claim 1, wherein the estimating of the clustering error includes:
in each of the plurality of data clusters:
retrieving data functions of data values in a data cluster;
computing a correlation of each pair of data functions for determining correlations of the data values in the data cluster; and
measuring the correlations for estimating a clustering error of the data cluster.

11. The method according to claim 1, further comprising:
modifying a weight for the clustering based on the adjusting of the composition of at least one of the plurality of data clusters.

12. The method according to claim 1, wherein the time series dataset includes a plurality of bond prices.

13. The method according to claim 1, wherein the adjusting indicates a change in correlation of the time series dataset over time.

14. The method according to claim 1, wherein the adjusting includes modifying the composition of at least one of the plurality of data clusters for maximizing intra-cluster correlation.

15. The method according to claim 1, wherein the adjusting includes modifying the composition of at least one of the plurality of data clusters for maximizing intra-cluster correlation minus out-of-cluster correlation.

16. The method according to claim 1, wherein the correlation of data values included in the time series dataset is measured via Pearson's coefficient.

17. The method according to claim 1, wherein each data value included in the time series dataset includes a plurality of dimensions utilized in the clustering.

18. The method according to claim 17, wherein the plurality of dimensions include maturity, ticker and industry type.

19. A system to determine clustering relevance in a volatile data environment and adjust clustering composition for improved accuracy, the system comprising:
a memory;
a display; and
a processor,
wherein the system is configured to perform:
plotting a time series dataset;
generating, by executing a machine learning (ML) algorithm and based on the plotted time series dataset, at least one grand truth data value;
clustering the plotted time series dataset for generating a plurality of data clusters, wherein the clustering is performed based on data correlation of individual data values included in the time series dataset;
training the ML algorithm independently for each of the plurality of data clusters for generating a managing ML algorithm, the managing ML algorithm including a plurality of sub-ML algorithms for each of the plurality of data clusters;
applying, by executing the managing ML algorithm to the time series dataset for predicting at least one future data value;
comparing differences between the at least one grand truth data value and the at least one future data value for estimating clustering error; and
adjusting composition of at least one of the plurality of data clusters based on the estimated clustering error.

20. A non-transitory computer readable storage medium that stores a computer program for determining clustering relevance in a volatile data environment and adjusting clustering composition for improved accuracy, the computer program, when executed by a processor, causing a system to perform a plurality of processes comprising:
plotting a time series dataset;
generating, by executing a machine learning (ML) algorithm and based on the plotted time series dataset, at least one grand truth data value;
clustering the plotted time series dataset for generating a plurality of data clusters, wherein the clustering is performed based on data correlation of individual data values included in the time series dataset;
training the ML algorithm independently for each of the plurality of data clusters for generating a managing ML algorithm, the managing ML algorithm including a plurality of sub-ML algorithms for each of the plurality of data clusters;
applying, by executing the managing ML algorithm to the time series dataset for predicting at least one future data value;
comparing differences between the at least one grand truth data value and the at least one future data value for estimating clustering error; and
adjusting composition of at least one of the plurality of data clusters based on the estimated clustering error.
